(19) United States
(12) Patent Application Publication
(10) Pub. No.: US 2010/0289325 A1
(43) Pub. Date: Nov. 18, 2010

(54) BRAKE SYSTEM OF A VEHICLE COMPRISING A VEHICLE DYNAMIC CONTROLLED AND A PRESSURE SENSOR INTEGRATED IN A SHUTTLE VALVE

(76) Inventor: Kurt Stanger, Leonberg (DE)

Correspondence Address: KENYON & KENYON LLP, ONE BROADWAY, NEW YORK, NY, 10004, US

(21) Appl. No.: 12/734,918

(22) PCT Filed: Dec. 5, 2008
(86) PCT No.: PCT/EP2008/010315

§ 371 Date: Jul. 22, 2010

(30) Foreign Application Priority Data
Dec. 14, 2007 (DE) 10 2007 060 271.7

(51) Int. Cl. B60T 8/34; B60T 15/14; B60T 8/175; B60T 8/176

(52) U.S. Cl. 303/113.2

(57) ABSTRACT

A brake system of a vehicle is described, including a vehicle dynamics controller (ESP) for influencing the vehicle behavior in the dynamic driving limit range, with a service brake valve for generating a pressure dependent on the driver's desired braking, at least one pressure sensor for generating a signal dependent on the pressure generated by the service brake valve, at least one shuttle valve including a valve member for transmitting the pressure generated by the service brake valve or an accumulator pressure or a pressure derived from the latter to at least one brake cylinder, depending on the level of the respective pressure acting on the valve member, in which at least one pressure sensor is integrated in a shuttle valve and is combined therewith to form an assembly.

### FIELD OF THE INVENTION

The present invention relates to a brake system of a vehicle, including a vehicle dynamics controller (ESP) for influencing the vehicle behavior in the dynamic driving limit range, with a service brake valve for generating a pressure dependent on a driver's desired braking, at least one pressure sensor for generating a signal dependent on the pressure generated by the service brake valve, at least one shuttle valve including a valve member for transmitting the pressure generated by the service brake valve or an accumulator pressure or a pressure derived from the latter to at least one brake cylinder, depending on the level of the respective pressure acting on the valve member.

### BACKGROUND INFORMATION

In the “Kraftfahrtechnisches Taschenbuch” of Robert Bosch GmbH, 26th edition 2007, Vieweg Verlag, pages 854ff and 898ff, discuss an electronic stability program (ESP).

In such ESP systems the control of the driving behavior in the dynamic driving limit range influences the three degrees of freedom of the vehicle in the plane (longitudinal, lateral and yaw velocity about the vertical axis), in terms of a driving behavior adapted to the driver's wish and to the road surface. For this purpose it is determined how the vehicle is to behave in the limit range according to the driver's wish (reference behavior) and how it actually behaves (actual behavior). In order to reduce the difference between actual and reference behavior, tire forces are then influenced by actuators of the controller. In order to determine the reference behavior, the signals, describing the driver's wish, of a steering wheel angle sensor (desired steering), of a pressure sensor (desired deceleration) and of the engine management system (desired drive torque), are evaluated.

Such ESP systems are usually based on brake systems which are equipped with an antilock system (ABS) and a traction control system (ASR). In this case the ESP utilizes the method already applied by the ASR to the drive axles to generate braking forces individually for each wheel independently of the driver's wish, by an ASR valve and the ABS valves connected downstream. The traction control system (ASR) also utilizes ABS components such as rotational speed sensors and pressure control valves. The control arrangement consists of a brake control circuit and an engine control circuit. The ASR brake control circuit additionally requires a shuttle valve for the pressure generated by the service brake valve or an accumulator pressure or a pressure derived from the latter to at least one brake cylinder, depending on the level of the respective pressure. Such a shuttle valve is allocated to each brake circuit of the service brake valve, for example to a front axle brake circuit and to a rear axle brake circuit.

In addition, in an ABS/ASR-based ESP the driver's desired deceleration must also be measured for each brake circuit by pressure sensors. The ESP therefore determines the driver's desired deceleration during an ESP intervention, which would not otherwise be possible on the basis of the function of the ASR valve. In this case, too, such a pressure sensor is allocated to each brake circuit of the service brake valve.

In the prior art, the pressure sensors allocated to the brake circuits of the service brake valve are integrated in the respective compressed air lines leading from the service brake valve to the shuttle valves.

It is an object of the exemplary embodiments and/or exemplary methods of the present invention to provide a brake system of a vehicle with a vehicle dynamics controller (ESP) based on an antilock system (ABS) and a traction control system (ASR) in such a manner that it is simpler and more cost-effective to produce and has greater reliability.

### SUMMARY OF THE INVENTION

This object may be achieved by the features described herein.

At least one pressure sensor may be integrated in a shuttle valve and combined therewith to form an assembly. This is because the shuttle valve is subjected to both the accumulator pressure and the pressure generated by the service brake valve, at least the latter pressure representing the driver's desired deceleration and having to be measured for ESP control, as was set out in the introduction.

Such an integration of the pressure sensor in the shuttle valve, or such combining of these components into an assembly, is effected by close spatial arrangement of the shuttle valve and the pressure sensor. For this purpose, the shuttle valve and the pressure sensor may be combined to form a constructional unit by
a) flange-joining their housings,
b) integrating them in a common housing.

This offers the advantage that the shuttle valve and the pressure sensor can be implemented together as an assembly which can be marketed separately, and the complexity and cost of the required laying of pressure medium lines directly on the vehicle is considerably reduced, since the individual pressure medium connections between the shuttle valve and the pressure sensor are already integrated in the assembly. As a result of this integration, the assembly can be preassembled and tested at the factory, especially to determine whether the connection to the pressure sensor is pressure-tight. Consequently, the complexity and cost of assembly and testing on the vehicle are substantially reduced. Furthermore, the receptacles for the pressure sensors otherwise required in the pressure lines are dispensed with.

Advantageous developments and improvements of the invention specified in the independent claims are possible by virtue of the measures stated in the dependent claims.

Especially, the shuttle valve and the pressure sensor may be accommodated in or on a common housing. This housing may be a casting.

In particular, the housing has at least four connections, a connection for a connecting line to a pressure accumulator, a connection for a connecting line to the service brake valve, a connection for a connecting line to the brake cylinder and a receptacle for at least partial insertion of the pressure sensor.

An especially short overall length of the assembly is obtained if the receptacle for insertion of the pressure sensor and the connection for the connecting line to the brake cylinder are arranged perpendicularly to a central axis of the housing, with which axis the connection for the connecting line to the pressure accumulator and the connection for the connecting line to the service brake valve, as well as the axially movable valve member of the shuttle valve, are arranged coaxially.

If, in addition, the receptacle for insertion of the pressure sensor is arranged substantially centrally between the connection for the connecting line to the pressure accumulator and the connection for the connecting line to the service brake valve, either the pressure in the connecting line to the service brake valve or the pressure in the connecting line to the pressure accumulator can be measured, depending on the position of the valve member of the shuttle valve. This offers extended functionality, as compared to the prior art.

If an especially shallow construction is desired, according to a further embodiment at least the receptacle for insertion of the pressure sensor and the connection for the connecting line to the brake cylinder may be arranged in a plane, in particular side-by-side. Then, however, a pressure supply to the pressure sensor is blocked by the valve member of the shuttle valve if a pressure is present at the connection for the connecting line to the pressure accumulator which is sufficiently great to force the valve member to a position in which it closes the connection for a connecting line to the service brake valve, or to open the pressure supply to the pressure sensor by the valve member of the shuttle valve if a pressure is present at the connection for the connecting line to the service brake valve which is sufficiently great to force the valve member to a position in which it closes the connection for a connecting line to the pressure accumulator. Consequently, as compared to the embodiment described previously, only the pressure generated by the service brake valve can be measured by the pressure sensor in this case.

More precise details will be apparent from the following description of an exemplary embodiment of the invention.

Exemplary embodiments of the invention are represented in the drawing and are explained in more detail in the following description.

### BRIEF DESCRIPTION OF THE DRAWINGS

FIG. 1 shows a cross-sectional representation of an assembly in which a shuttle valve and a pressure sensor are combined according to an exemplary embodiment of the invention.

FIG. 2 shows a cross-sectional representation of an assembly in which a shuttle valve and a pressure sensor are combined according to a further exemplary embodiment of the invention.

### DETAILED DESCRIPTION

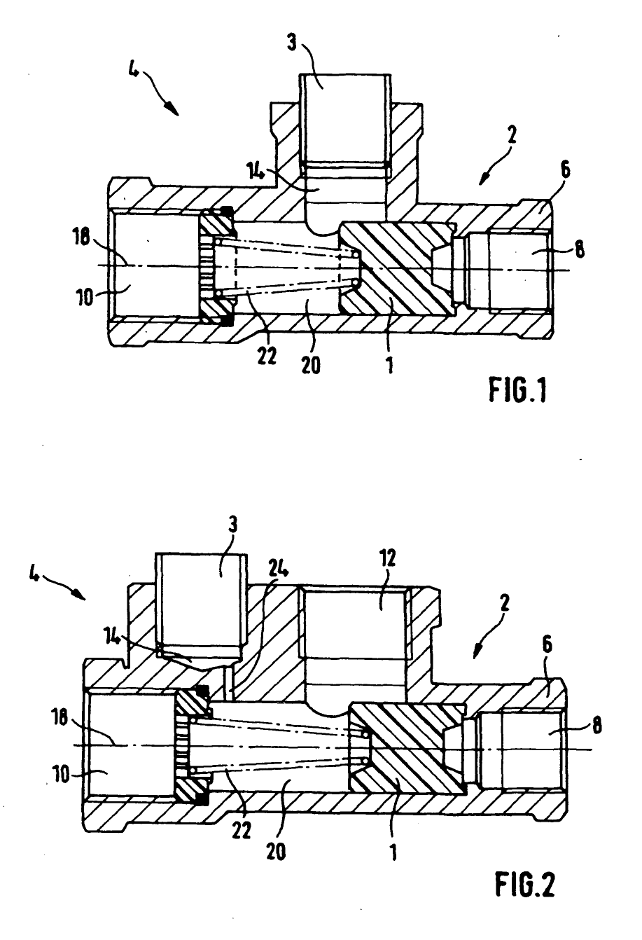

As described in the introduction, brake systems of vehicles with a vehicle dynamics controller (ESP) for influencing the vehicle behavior in the dynamic driving limit range have a service brake valve for generating a pressure dependent on the driver's desired braking, at least one pressure sensor for generating a signal dependent on the pressure generated by the service brake valve, at least one shuttle valve 2 including a valve member 1 for transmitting the pressure generated by the service brake valve or an accumulator pressure or a pressure derived from the latter to at least one brake cylinder, depending on the level of the respective pressure. For reasons of scale, only one assembly 4, including the shuttle valve 2, is shown in FIG. 1.

It is proposed that at least one pressure sensor 3 is integrated in a shuttle valve 2 and combined therewith to form an assembly 4. Especially, the shuttle valve 2 and the pressure sensor 3 may be accommodated in or on a common housing 6, as shown in the embodiment according to FIG. 1. This housing 6 may be a casting.

In particular, the housing 6 has at least four connections, a connection 8 for a connecting line to a pressure accumulator, a connection 10 for a connecting line to the service brake valve, a connection 12 for a connecting line to the brake cylinder and a connection 14 for at least partial insertion of the pressure sensor 3. The latter connection 14 forms a receptacle for the pressure sensor 3, which may be screwed into the receptacle 14 and the sensing surface of which is oriented towards the pressure to be measured.

The valve member 1 of the shuttle valve 2 is arranged coaxially in the housing 6 between the connection 8 for the connecting line to the pressure accumulator and the connection 10 for the connecting line to the service brake valve, in order, depending on the respective pressures at these connections 8, 10, to transmit either the accumulator pressure or the pressure delivered by the service brake valve to the connection 12 for the connecting line to the brake cylinder. In the embodiment according to FIG. 1, this connection 12 for the connecting line to the brake cylinder is arranged, for example, at 90 degrees to a plane which contains the central axis 18 of the housing 6 and thus extends perpendicularly into the drawing plane in FIG. 1 and therefore is not visible in this illustration. The four connections 8, 10, 12 and 14 then open into a central chamber 20 of the housing 6 in which the valve member 1 of the shuttle valve 2 is guided.

The valve member 1 of the shuttle valve 2 is preloaded, for example by at least one spring element 22, to a position in which it may close the connection 8 for the connecting line to the pressure accumulator. Alternatively, it could be preloaded to a position in which it closes the connection 10 for the connecting line to the service brake valve. Consequently, in the present embodiment the accumulator pressure must be greater than the pressure delivered by the service brake valve by at least the spring force, in order that the valve member 1 closes the connection 10 for the connecting line to the service brake valve against the effect of the spring element 22 and directs the accumulator pressure to the brake cylinder. An ASR valve may be arranged in the pressure line between the connection 8 for the connecting line to the pressure accumulator and the pressure accumulator, so that such a connection may also be of an indirect kind. Furthermore, an ABS pressure control valve, for example, may be arranged in the pressure line between the connection 12 for the connecting line to the brake cylinder and said brake cylinder.

As to FIG. 1, the receptacle 14 for insertion of the pressure sensor 3, as a threaded receiving bore which opens perpendicularly into the chamber 20, may be arranged, like the connection 12 for the connecting line to the brake cylinder, perpendicularly to the central axis 18 of the housing 6, with which central axis the connection 8 for the connecting line to the pressure accumulator and the connection 10 for the connecting line to the service brake valve, and the axially movable valve member 1 of the shuttle valve 2, are arranged coaxially. The receptacle 14 for insertion of the pressure sensor 3 and the connection 12 for the connecting line to the brake cylinder may then be arranged, for example, in a plane perpendicular to the central axis 18 and offset to one another by 90 degrees or 180 degrees. The connections 8, 10 and 12 of the assembly 4 may be provided with internal threads for insertion of corresponding pressure line fittings.

If, as in the embodiment according to FIG. 1, the receptacle 14 for insertion of the pressure sensor 3 is arranged substantially centrally between the connection 8 for the connecting line to the pressure accumulator and the connection 10 for the connecting line to the service brake valve, either the pressure in the connecting line to the service brake valve or the pressure in the connecting line to the pressure accumulator can be measured by the pressure sensor 3, depending on the position of the valve member 16 of the shuttle valve 2, since the pressure sensor 3 is then in pressure communication with the central chamber 20.

In the second exemplary embodiment of the invention according to FIG. 2, the parts which remain the same and have the same effect, as compared to the preceding example, are denoted by the same reference numerals. In contrast to the first exemplary embodiment, all four connections 8, 10, 12 and 14 are arranged in a plane which contains the central axis 18 of the housing 6. In particular, the connection 12 for the connecting line to the brake cylinder and the receptacle 14 for the pressure sensor 3 are here arranged parallel side-by-side and perpendicularly to the central axis 18.

Between the central chamber 20, in which the valve member 16 is guided axially, that is coaxially with or parallel to the central axis 18, and the receptacle 14 for the pressure sensor, there is provided a pressure channel 24 which leads from the chamber 20 into the receptacle 14 for the pressure sensor 3, which is here in the form of a blind bore. The opening of this pressure channel 24 into the chamber 20 is closed by the valve member 1 of the shuttle valve 2 if a pressure is present at the connection 8 for the connecting line to the pressure accumulator which is sufficiently great to force the valve member 1 to a position in which it closes the connection 10 for the connecting line to the service brake valve. The pressure at the connection 8 can then be measured, but not that at the connection 10.

On the other hand, the opening of the pressure channel 24 into the chamber 20 is opened by the valve member 16 of the shuttle valve 2 if a pressure is present at the connection 10 for the connecting line to the service brake valve which is sufficiently great to force the valve member 1 to a position in which it closes the connection 8 for the connecting line to the pressure accumulator. This position is shown in FIG. 2. Consequently, as compared to the embodiment of FIG. 1, in this case only the pressure generated by the service brake valve at the connection 10 can be measured by the pressure sensor 3, but not the accumulator pressure at connection 8.

According to a further embodiment, not graphically represented here, the receptacle 14 for the pressure sensor 3, on the one hand, and the connection 12 for the connecting line to the brake cylinder or the connection 8 for the connecting line to the pressure accumulator or the connection 10 for the connecting line to the service brake valve, on the other, may be combined to form one connection. The pressure sensor 3 then measures the pressure present at a given time at the connection concerned.

### The List of Reference Numerals is as Follows:

1 Valve member

2 Shuttle valve

3 Pressure sensor

4 Assembly

6 Housing

8 Connection

10 Connection

12 Connection

14 Connection

18 Central axis

20 Chamber

22 Spring element

24 Pressure channel

1-10. (canceled)

11. A brake system for a vehicle, comprising:
a vehicle dynamics controller (ESP) for influencing a vehicle behavior in a dynamic driving limit range;
a service brake valve for generating a pressure dependent on a driver's desired braking;
at least one pressure sensor for generating a signal dependent on a pressure generated by the service brake valve;
at least one shuttle valve including a valve member for transmitting one of (i) the pressure generated by the service brake valve, (ii) an accumulator pressure, and (iii) a pressure derived from the latter to at least one brake cylinder, depending on the level of the respective pressure acting on the valve member;
wherein at least one pressure sensor is integrated in a shuttle valve and is combined therewith to form an assembly.

12. The brake system of claim 11, wherein the shuttle valve and the pressure sensor are accommodated one of in and on a common housing.

13. The brake system of claim 12, wherein the housing includes at least four connections, including a connection for a connecting line to a pressure accumulator, a connection for a connecting line to the service brake valve, a connection for a connecting line to the brake cylinder, and a receptacle for at least accommodating a partial insertion of the pressure sensor.

14. The brake system of claim 13, wherein the receptacle for insertion of the pressure sensor and the connection for the connecting line to the brake cylinder are arranged perpendicularly to a central axis of the housing, with which central axis the connection for the connecting line to the pressure accumulator and the connection for the connecting line to the service brake valve, and the axially movable valve member of the shuttle valve, are arranged coaxially.

15. The brake system of claim 14, wherein the receptacle for insertion of the pressure sensor and the connection for the connecting line to the brake cylinder are arranged in a plane perpendicular to the central axis of the housing and are offset at an angle to one another.

16. The brake system of claim 14, wherein the receptacle for insertion of the pressure sensor is arranged substantially centrally between the connection for the connecting line to the pressure accumulator and the connection for the connecting line to the service brake valve, to measure either the pressure in the connecting line to the service brake valve or the pressure in the connecting line to the pressure accumulator, depending on the position of the valve member of the shuttle valve.

17. The brake system of claim 13, wherein the receptacle for insertion of the pressure sensor and the connection for the connecting line to the brake cylinder, together with the connection for the connecting line to the pressure accumulator and the connection for the connecting line to the service brake valve, are arranged in a plane containing the central axis of the housing.

18. The brake system of claim 17, wherein the receptacle for insertion of the pressure sensor and the connection for the connecting line to the brake cylinder are arranged side-by-side, a pressure supply to the pressure sensor being closed by the valve member of the shuttle valve if a pressure is present at the connection for the connecting line to the pressure accumulator which is sufficiently great to force the valve member to a position in which it closes the connection for a connecting line to the service brake valve, while on the other hand the pressure supply to the pressure sensor is opened by the valve member of the shuttle valve if a pressure is present at the connection for the connecting line to the service brake valve which is sufficiently great to force the valve member to a position in which it closes the connection for a connecting line to the pressure accumulator.

19. The brake system of claim 13, wherein the receptacle for the pressure sensor and the connection for the connecting line to the brake cylinder, or the connection for the connecting line to the pressure accumulator or the connection for the connecting line to the service brake valve, are combined to form one connection.

20. The brake system of claim 11, wherein the valve member of the shuttle valve is preloaded by at least one spring element to a position in which it closes the connection for the connecting line to the pressure accumulator or to a position in which it closes the connection for the connecting line to the service brake valve.
